(19) United States
(12) Patent Application Publication
(10) Pub. No.: US 2007/0255618 A1
(43) Pub. Date: Nov. 1, 2007

(54) System and method for improving online advertising effectiveness and promoting digital content creation

(76) Inventors: Jason R. Meerbergen, San Diego, CA (US); Tim William Smith, Carlsbad, CA (US)

Correspondence Address: ROGITZ & ASSOCIATES, 750 B STREET, SUITE 3120, SAN DIEGO, CA, 92101, US

(21) Appl. No.: 11/605,907

(22) Filed: Nov. 29, 2006

Related U.S. Application Data
(60) Provisional application No. 60/795,947, filed on Apr. 28, 2006.

(51) Int. Cl. G06Q 30/00

(52) U.S. Cl. 705/14

(57) ABSTRACT

Metadata is associated with videos and photos that are posted on community websites. The metadata represents information about the camera that generated the content and/or information about the content itself, and is associated with demographic information of the image provider. Targeted advertising can be generated for service on the community website using the metadata with demographic information, and advertising revenue may be shared between the community website, camera manufacturer, and videographer/photographer.

### RELATED APPLICATION

This application claims priority from U.S. provisional patent application Ser. No. 60/795,947, filed Apr. 28, 2006.

### I. FIELD OF THE INVENTION

The present invention relates generally to systems and method for improving the effectiveness of online advertising and for promoting the creation of digital content.

### II. BACKGROUND OF THE INVENTION

Various Internet technologies have been developed for “serving” advertisements, i.e., for providing advertisements on the Internet. As critically recognized herein, however, current ad serving schemes fail to recognize the advantages of accounting for the degree or types of metadata that, as envisioned herein, can be contained in photos or video that might be placed close to or otherwise be accompanied by the advertisement. The present invention understands that such metadata can be used to better target advertising.

Additionally, the present invention critically recognizes that advantages can be leveraged from compensating the creator of a video or photograph that might be accompanied by an advertisement for user activity that is related to the ad. For example, advantages can be leveraged from compensating the creator of a video or photograph when users click on an advertisement that accompanies the video or photo. With these critical recognitions in mind, the invention herein is provided.

### SUMMARY OF THE INVENTION

Metadata is associated with a file representing a video and/or a photograph. The metadata represents a type of camera (including model, age, unique identifier, still/motion) that generated the video and/or photograph, and/or content information pertaining to the video and/or photograph. By “camera” is meant any still or motion imaging device, system, or software that is incorporated into any CE or IT device, including standalone cameras, wireless telephones with imaging capability, “Mylos”, laptops, CCTVs, etc.

In any case, the file is provided to a website, and the metadata is correlated to demographic data associated with a human provider of the file. Advertising revenue is shared between the website and the human provider if the provider renders personal demographic information, and is also shared with the manufacturer (which includes not only the maker of the camera but also distributors and retailers) of the camera, in some implementations based on a targeted advertisement premium.

In another aspect, a system includes at least one camera generating a photo and/or video, means for associating metadata with the photo and/or video, and means for correlating the metadata to demographic information and unique identification information representing the photo and/or video. Means are provided for determining advertising revenue sharing based at least in part on the metadata and unique identification information.

In yet another aspect, a method includes associating respective metadata with respective pieces of content posted on a website. The metadata represents information about a camera that generated the respective piece content and/or information about the respective piece of content itself. According to this aspect, the method also includes correlating the metadata with demographic information of a provider of the piece of content, and generating advertising for service on the website using the metadata with demographic information. Revenue associated with the advertising revenue is shared between the website, camera manufacturer, and provider.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting system in accordance with present principles, showing some of the data communication between entities;

FIG. 2 is a flow chart showing the logic of targeting ads based on video/photo metadata; and

FIG. 3 is a flow chart showing the logic of revenue sharing between advertiser, content provider, and camera manufacturer.

### DETAILED DESCRIPTION OF THE PREFERRED EMBODIMENT

The present invention, among other non-limiting advantages, improves the targeting of advertisements to individuals that view digital video content or digital photo content on various content and community websites and similar distribution channels. Aspects disclosed herein also establish a viable and incentivizing revenue sharing arrangement between a website or similar channel and the manufacturer of the photo/video camera (and also the provider of software therefor) for the premium created by the additional targeting of advertising based on accompanying videos/photos. This allows the website to share with the software provider/manufacturer only the value that the software provider/manufacturer provides through the process and technology. Furthermore, by creating a revenue model that shares advertising revenue with the actual creator of the video or photo content, greater incentive exists for content production and content posting/publishing, effectively resulting in a more active community with more content for the community/content websites. Moreover, photo/video creators are enabled to monetize their efforts with significantly lower economic barriers to entry than other channels and methods such as TV production.

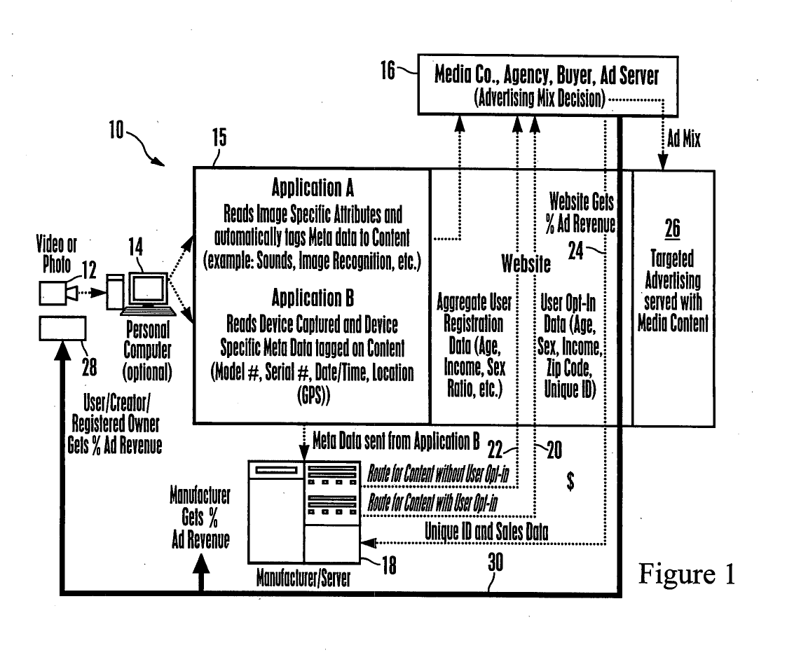

Referring initially to FIG. 1, a system is shown, generally designated 10, which includes plural still and/or video cameras 12 (only a single camera 12 shown for clarity of disclosure). In one implementation the camera 12 is a digital camera, and digital photo and/or video files can be transferred from the camera 12 to a personal computer 14 typically owned by the owner of the camera 12. In some embodiments the camera 12 and PC 14 can be implemented in a single device. Or, the PC 14 may be excluded because the camera might be wireless and might communicate directly with the below-described community website. Thus, it is to be understood that when reference is made to the PC communicating, the communication could be from the camera itself or from a server.

As indicated in FIG. 1, the PC 14 or one or more community websites 15 with which the PC 14 communicates to post camera 12 photos and/or videos may execute one or more software applications to ensure that certain metadata is included in digital photo/video files. By “community website” or “community site” is meant any individual, group, corporate, association website that includes numerous user-generated images. Specifically, a first software application “A” can examine the files for specific attributes of the images and/or sounds represented in the files, e.g., whether classical music, or speaking, or some other sound is represented by a video file and/or whether a particular image (e.g., a particular person) or image type (e.g., any human) or other image attribute is captured in the file. To this end, image recognition techniques known in the art can be employed. The first application “A” then automatically appends metadata to each examined file to indicate the type of image and/or sound represented in the file.

Also, in some implementations the PC 14 and/or community website 15 can execute a second software application “B” that reads certain metadata that the camera 12 may have appended to the photo/video file, such as camera model number, serial number, date and time of taking the photo/video, and the location at which the file was generated using, e.g., information from a GPS module that accompanies the camera 12. GPS may be built into the camera or it might be a separate module connected to the camera.

Applications “A” and “B” might alternatively reside on a server outside of the manufacturer/community websites, e.g., at a server associated with an ad server or media company.

In general, this type of information is sometimes referred to as “Exchangeable Image File” (EXIF) data. In one non-limiting implementation, in addition to the above, the EXIF data may include but may not be limited to date/time of imaging along with GPS location of where the image was taken, file name, shooting mode, photo effect, shutter speed, aperture value, light metering, exposure compensation, ISO speed, lens type, focal length, whether zoom was used, IS mode, image size, image quality, and whether a flash was used and if so what type.

As indicated in FIG. 1, the photo/video content with metadata added by the first application “A” can be sent to an ad server 16 that might be associated with a media company, ad agency, or ad buyer. Also, if desired the metadata read by the second application “B” along with, if desired, the associated video/photo content may be sent to a manufacturer server 18 that is associated with the manufacturer of the camera 12. When the user of the camera 12 has opted in to provide his demographic information (including, e.g., his age, sex, income, location, interests, activities, property and personal relationships/associations, etc.) pursuant to using the second application “B”, the manufacturer server 18 can communicate this demographic information along a path 20 to the ad server 16. Also, the manufacturer server 18 can communicate aggregated user information along a path 22 to the ad server 16 in the case of users who have opted not to provide their demographic information. This aggregated user information can include aggregate user age, income, sex ratio, etc. as gleaned from the demographic data that is provided by users opting in.

In turn, the ad server 16 can communicate revenue information to the manufacturer server 18 along a path 24, in accordance with disclosure below. The ad server is used to create targeted advertisements 26 using the information supplied to it by the applications “A” and/or “B” that is then “served with” the relevant content, e.g., photos or videos that are posted on community websites. Ad revenue information is also communicated to both the manufacturer server 18 and user 28 of the camera 12/PC 14 along a path 30 in accordance with logic below.

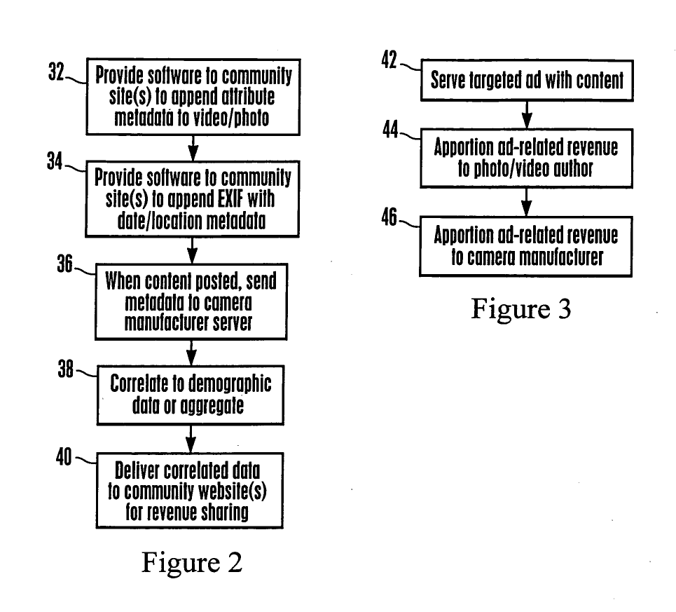

With the above non-limiting architecture in mind, attention is now drawn to FIG. 2. Commencing at block 32, an entity such as the camera 12 manufacturer licenses the first application “A” to community and content websites 15. The websites 15 are allowed to automatically append metadata to media content (video and photo) according to the attributes of the media (sound recognition, image recognition, etc.) as mentioned above when users post the content on the websites. Alternately, as also mentioned above the individual user PCs 14 may execute the application “A”.

Proceeding to block 34, the application “B” likewise may be licensed to the community websites 15. Then, at block 36, the above metadata from applications “A” and “B” is sent to the manufacturer server 18, along with the user's demographic information provided the user has opted in to provide it. At block 38 the server 18 correlates the demographic data with the metadata and assigns unique identification numbers to metadata correlations for each piece of content. If no demographic information has been provided the server 18 can correlate the metadata with aggregated consumer data for the specific device model number of the camera that generated the content. At block 40 the manufacturer server 18 delivers, for each piece of content, the associated demographic data, correlated to the metadata for the piece of content as indicated by the unique ID, to the ad server 16 and/or community website 15.

FIG. 3 illustrates how revenue may be shared among the community website 15, manufacturer of the camera 12, and for users who opt in to provide their demographic data, the users of the cameras 12 (i.e., the content providers.) At block 42 the ad server 16 provides targeted advertisements on the community website 15 next to, before, after or spliced within the photos/video that are served on the community website 15.

Moving to block 44, for users who have posted photos/videos on the website 15 and have provided their demographic information, revenue generated from sales of advertisement and/or subscription is shared with the users. In essence, the creator of a small video clip that has posted the video to a community website 15 is paid a percentage of advertising sales for each time someone views their photo/video and an advertisement is served next to, before, after or even spliced within the photo/video, and revenue is generated from that advertisement.

Also, at block 46 the community website 15 shares advertising and/or subscription revenue with the manufacturer of the camera 12. For instance, revenue sharing may be based on an agreed percentage of the premium created by the enhanced targeting functionality. This premium can be determined by subtracting the average revenue generated from a unit of non-targeted or less-targeted advertising from the revenue generated from a unit of targeted or more-targeted advertising. For example, if a non-targeted advertisement is sold on average for $4 cost per thousand ad impressions and a targeted advertisement is sold for $20, the community site 15 can share an agreed-upon percentage of the $16 premium with the manufacturer of the camera 12. The calculations above may be executed at any of the computers disclosed herein.

While the particular SYSTEM AND METHOD FOR IMPROVING ONLINE ADVERTISING EFFECTIVENESS AND PROMOTING DIGITAL CONTENT CREATION is herein shown and described in detail, it is to be understood that the subject matter which is encompassed by the present invention is limited only by the claims.

What is claimed is:

1. A method comprising:
associating metadata with a file representing a video and/or a photograph, the metadata representing at least one of: a camera type or specific camera ID that generated the video and/or photograph, or content information pertaining to the video and/or photograph, the file being provided to a website;
correlating the metadata to demographic data associated with a human provider of the file; and
sharing advertising revenue between the website and at least one of: the human provider, or the manufacturer of the camera.

2. The method of claim 1, wherein the metadata represents at least a type of camera.

3. The method of claim 1, wherein the metadata represents at least content information.

4. The method of claim 1, wherein advertising revenue is shared with the manufacturer of the camera.

5. The method of claim 1, wherein advertising revenue is shared with the manufacturer of the camera based at least in part on the use of the image to define targeted advertising.

6. The method of claim 1, wherein advertising revenue is shared with the human provider of the file.

7. The method of claim 6, wherein the human provider receives a portion of revenue for each time someone views the file provided by the human provider and an advertisement is served with the file and revenue is generated from the advertisement.

8. A system, comprising:
at least one camera generating a photo and/or video;
means for associating metadata with the photo and/or video;
means for correlating the metadata to demographic information and unique identification information representing the photo and/or video; and
means for determining advertising revenue sharing based at least in part on the images or metadata and unique identification information.

9. The system of claim 8, wherein the means for associating is a community website executing logic, the means for correlating is a server associated with a manufacturer of the camera and executing logic.

10. The system of claim 8, wherein the metadata represents at least a type of camera.

11. The system of claim 8, wherein the metadata represents at least content information.

12. The system of claim 8, wherein advertising revenue is shared with a manufacturer of the camera.

13. The system of claim 8, wherein advertising revenue is shared with a provider of the photo and/or video.

14. A method, comprising:
associating respective metadata with respective pieces of content posted on a website, the metadata representing information about a camera that generated the respective piece content and/or information about the respective piece of content itself;
correlating the metadata with demographic information of a provider of the piece of content;
generating advertising for service on the website using the metadata with demographic information; and
sharing revenue associated with the advertising between the website, camera manufacturer, and provider.

15. The method of claim 14, wherein the metadata represents at least a type of camera.

16. The method of claim 14, wherein the metadata represents at least content information.

17. The method of claim 14, wherein advertising revenue is shared with the manufacturer of the camera based at least in part on a targeted advertisement premium.

18. The method of claim 14, wherein advertising revenue is shared with the provider.

19. The method of claim 18, wherein the provider receives a portion of revenue for each time someone views the piece of content provided by the provider and an advertisement is served next to, before, after or spliced within the piece of content and revenue is generated from the advertisement.
